(19) United States
(12) Patent Application Publication
(10) Pub. No.: US 2005/0188035 A1
(43) Pub. Date: Aug. 25, 2005

(54) Efficient mail filtering techniques

(75) Inventor: Hiroshi Ueno, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/038,089

(22) Filed: Jan. 21, 2005

(30) Foreign Application Priority Data
Jan. 21, 2004 (JP) 2004-012543

(51) Int. Cl. G06F 15/16

(52) U.S. Cl. 709/206

(57) ABSTRACT

A mail filter device allowing processing time to be reduce is provided. The SMTP processor relays commands and responses exchanged between SMTP client and SMTP server and performs content check during message relaying. TCP/IP terminations share header information through a connection manager, keeping TCP/IP header information identical both between the SMTP client and the mail filter device and between the mail filter device and the SMTP server. When the content check determines that the electronic mail is relayed without discarding its message, the SMTP processor transfers a response to the SMTP client when the SMTP server has completed relay processing.

### BACKGROUND OF THE INVENTION

1. Field of the Invention

The present invention relates to a mail filtering system and in particular to a mail filter device which relays electronic mails.

2. Description of the Related Art

As a standard protocol for electronic mails in the Internet, SMTP (Simple Mail Transfer Protocol) has been known, which can provide mail relaying from a sender to an ultimate destination like a bucket brigade between a computer and a server. See RFC (Request For Comments) 2821, April 2001, pp. 15-19.

According to SMTP, even if a server to which an electronic mail is forwarded stops, the electronic mail is stored in a storage device and, after a lapse of a predetermined time interval, resent to the server, resulting in reliable mail delivery. For this purpose, a mail server for relaying and delivering mails is generally implemented by software programs running on a computer provided with a storage device such as a magnetic disk. A filtering operation of a conventional mail filter device will be described by referring to FIG. 1.

As shown in FIG. 1, the mail filter device receives an electronic mail from a SMTP client through a sequence as indicated by steps e1-e5 and then writes the received mail onto a storage device (not shown in this figure). When the received mail has been written to the storage device, the mail filter device sends an OK response back to the SMTP client as indicated by step e6. When the OK response has been sent to the SMTP client, the responsibility for delivering the mail is fulfilled by the SMTP client and falls on the mail filter device. The subsequent steps are performed between the mail filter device and the SMTP server. The mail filter device checks the content of the electronic mail stored in the storage device and, when it is determined which destination addresses should be transferred, notifies the SMTP server of the destination addresses to be transferred (steps e7-e11).

When the SMTP server has completely received the electronic mail, the SMTP server sends an OK response back to the mail filter device as indicated by step e12. When the OK response has been received from the SMTP server, the mail filter device has no responsibility for delivering the mail and therefore is permitted to delete the message from the storage device.

In FIG. 1, “HELO (HELLO)” is an open command when a session is initiated and “EHLO” is an extended open command for informing that the extended function of “HELLO” is used. The server uses these commands to initiate a session to the client. “RCPT (RECIPIENT)” is a command of informing the server of a destination address.

The conventional mail filter device as described above is implemented on a computer having a storage device such as a magnetic disk. Accordingly the filter operation involves disk accesses, which cause per-mail processing time to elongate, thereby reducing filter performance.

Since the relaying operation of the conventional mail filter device is similar to that of an SMTP server, all electronic mails, from the view point of a destination SMTP server, are received from mail filter devices, which means that source host information have been lost. Therefore the SMTP server cannot perform log analysis, statistical processing, connection control and the like based on source host information.

Further the conventional mail filter device terminates TCP/IP (Transmission Control Protocol/Internet Protocol) and relays IP packets with attaching different IP and TCP headers before and after the mail filter device. Accordingly, in the case where a relay device having a filter function is installed, it is necessary to change the settings of both client and server.

In addition, as described above, the conventional mail filter device is implemented on a computer having a storage device such as a magnetic disk and thereby the processing time required for each mail is elongated, resulting in reduced filter performance.

### SUMMARY OF THE INVENTION

An object of the present invention is to provide mail filter system, device and method, which can reduce time required for filter processing.

Another object of the present invention is to provide mail filter system, device and method, which can efficiently delete the delivery command for an unknown destination address.

According to an aspect of the present invention, a mail filter system includes a mail filter device for mail filtering, which relays an electronic mail between a client device and a server device. The mail filter device is provided with a connection manger for registering header information before and after the mail filter device and uses the header information established with the client device for a connection to the server device.

The mail filter device may further include a means for checking whether a destination address of the electronic mail to be relayed matches an unknown destination address which is previously set when the electronic mail is relayed at the mail filter device.

According to another aspect of the present invention, a mail filter device for filtering electronic mails, at which an electronic mail is relayed between a client device and a server device, includes: a connection manager which registers header information before and after relaying the electronic mail, wherein header information established for one of the client-side connection and the server-side connection is used for the other one of the client-side connection and the server-side connection.

A mail filter device may further include a means for checking whether a destination address of the electronic mail to be relayed matches an unknown destination address which is previously set when the electronic mail is relayed at the mail filter device.

According to still another aspect of the present invention, a mail filtering method for filtering electronic mails and relaying an electronic mail between a client device and a server device, includes the steps of: registering header information before and after relaying the electronic mail; and using header information established for one of the client-side connection and the server-side connection as header information for the other one of the client-side connection and the server-side connection.

A mail filtering method may further include the step of determining whether a destination address of the electronic mail matches a predetermined destination unknown address when the electronic mail is relayed.

As described above, a mail filter device according to the present invention registers header information before and after relaying into a connection manager, allowing header information, for example, for client-side connection to be used for server-side connection.

Further, according to the present invention, the SMTP processor performs issue and transfer of a command and its response for the client device and the server device when relaying the electronic mail. Accordingly, transfer and deletion of an electronic mail can be made depending on a content check result without storing the message of the electronic mail into a storage device such as a magnetic disk. This causes the mail filter device to be installed as transparent security equipment without changing the settings of the mail server in electronic mail filter processing.

More specifically, the SMTP processor performs relaying the command and response exchanging between the client device and the server device and, when relaying a message of the electronic mail, performs content check on the message of the electronic mail.

The termination section can share the TCP/IP header information through the connection manager, so that TCP/IP header information (IP address, TCP port number) can be kept identical both between the client device and the mail filter device and between the mail filter device and the server device.

Further, when a result of the content check indicates that the electronic mail is relayed without discarding the message of the electronic mail, the SMTP processor transfers the response to the client device on completion of relay processing by the server device.

Accordingly, the electronic mail can be relayed without burdening the mail filter device with the responsibility of message delivery. Therefore, the message of the mail is not stored in a storage device such as a magnetic disk, resulting in higher speed filter processing.

According to the present invention, IP header information can be maintained when relaying between client-side and server-side without a storage device. In other word, electronic mail relaying can be realized without a storage device such as magnetic disk, thereby reducing the processing time per mail. In addition, by using dedicated processing sections for TCP/IP termination, command analysis, SMTP processing, retrieval and the like, further higher speed filter processing can be realized.

From another aspect of the present invention, the mail filter device uses the connection manager to associate the TCP/IP terminations with storing the header information, so that the SMTP client and SMTP server can make transparent transfer with respect to IP address and TCP port number. Accordingly, at the SMTP server, it is possible to make relay determination depending on the IP address information of the SMTP client. At the same time, there is no need of changing the setting of both the SMTP server and the SMTP client.

Further, the mail filter device according to the present invention has a function of determining a destination unknown address without referring to a database of user information, allowing efficient deletion of delivery command for destination unknown address.

As described above, according to the present invention, time required for filter processing can be shortened and delivery commands for destination unknown addresses can be efficiently deleted.

### BRIEF DESCRIPTION OF THE DRAWINGS

FIG. 1 is a diagram showing a transfer sequence of an electronic mail between a SMTP client and a SMTP server via a conventional mail filter device;

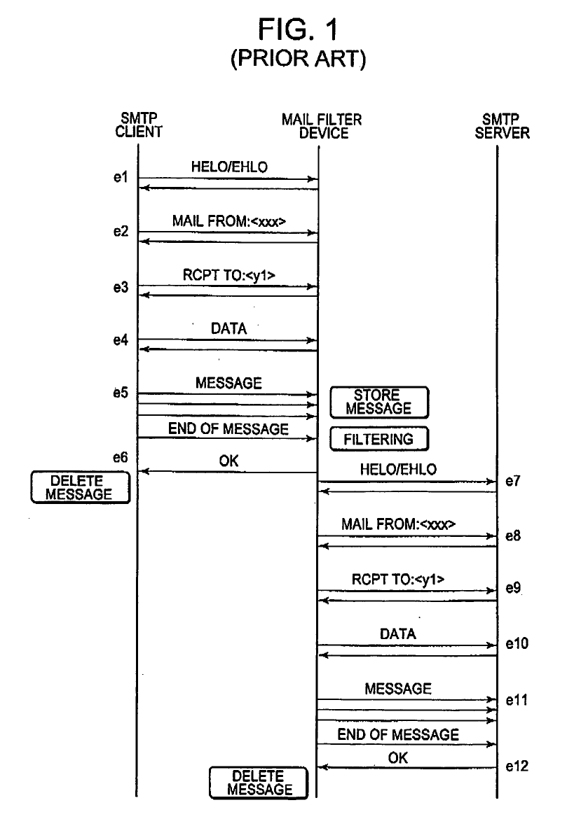

FIG. 2 is a block diagram showing a mail filter system according to a first embodiment of the present invention;

FIG. 3 is a diagram showing an example of a connection management table in a connection manager of the mail filter device as shown in FIG. 2;

FIG. 4 is a flowchart showing an IP packet reception operation at TCP/IP termination 11 of the mail filter device as shown in FIG. 2;

FIG. 5 is a flowchart showing an IP packet reception operation at TCP/IP termination 12 of the mail filter device as shown in FIG. 2;

FIG. 6 is a flowchart showing an IP packet transmission operation at TCP/IP termination 11/12 of the mail filter device as shown in FIG. 2;

FIG. 7 is a flowchart showing a first part of protocol processing of a SMTP processor of the mail filter device as shown in FIG. 2;

FIG. 8 is a flowchart showing a second part of the protocol processing of a SMTP processor of the mail filter device as shown in FIG. 2;

FIG. 9 is a flowchart showing a third part of the protocol processing of a SMTP processor of the mail filter device as shown in FIG. 2;

FIG. 10 is a flowchart showing a forth part of the protocol processing of a SMTP processor of the mail filter device as shown in FIG. 2;

FIG. 11 is a diagram showing a first example of a transfer sequence of an electronic mail between a SMTP client and a SMTP server via a mail filter device in the mail filter system according to the first embodiment of the present invention;

FIG. 12 is a diagram showing a second example of a transfer sequence of an electronic mail between a SMTP client and a SMTP server via a mail filter device in the mail filter system according to the first embodiment of the present invention;

FIG. 13 is a diagram showing a third example of a transfer sequence of an electronic mail between a SMTP client and a SMTP server via a mail filter device in the mail filter system according to the first embodiment of the present invention;

FIG. 14 is a diagram showing an example of a unknown user registration table in a connection manager of the mail filter device as shown in FIG. 2; and

FIG. 15 is a diagram showing a transfer sequence of an electronic mail between a SMTP client and a SMTP server via a mail filter device in the mail filter system according to a second embodiment of the present invention.

### DESCRIPTION OF THE PREFERRED EMBODIMENTS

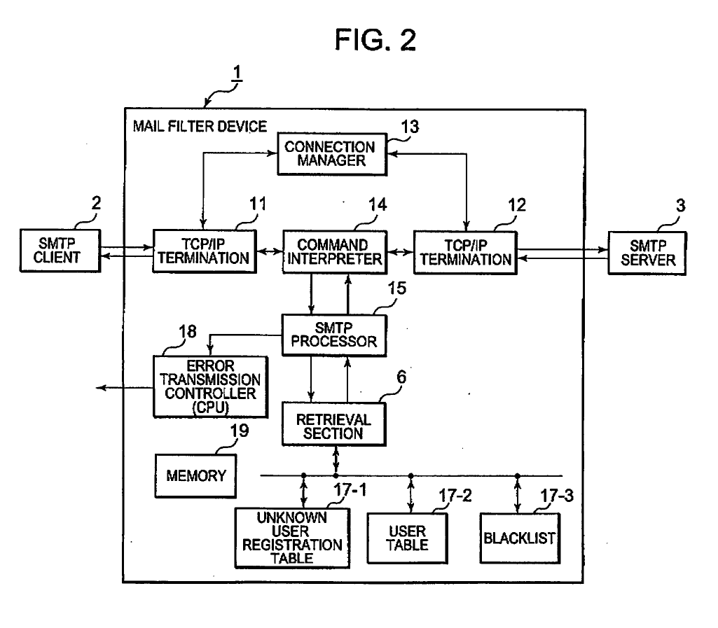

Referring to FIG. 2, a mail filter system according to a first embodiment of the present invention includes a mail filter device 1, which is inserted between a SMTP client 2 and a SMTP server 3 and functions as a relay station for electronic mails.

The mail filter device 1 has a TCP/IP termination 11 for the SMTP client 2 and a TCP/IP termination 12 for the SMTP server 3. The mail filter device 1 further includes a connection manager 13, a command interpreter 14, a SMTP processor 15, and a retrieval section 16. The retrieval section 16 is connected to an information table composed of an unknown user registration table 17-1, a user table 17-2 and a black list 17-3. The SMTP processor 15 controls an error transmission controller 18. These functions may be realized by programs running on a computer. A memory 19 stores such computer-readable programs.

The connection manager 13 manages TCP connection and the command interpreter 14 interprets an octet stream extracted from the TCP/IP terminations 11 and 12. The SMTP processor 15 performs SMTP interpretation based on SMTP command or SMTP response interpreted by the command interpreter 14.

The retrieval section 16 retrieves data to be retrieved, which is obtained by the SMTP processor 15, by referring to the information table 17-1, 17-2, and 17-3 storing retrieval entries. The error transmission controller 18 creates an error notification mail and performs transmission processing as a mail client in the case where the SMTP processor 15 determines that error notification is needed.

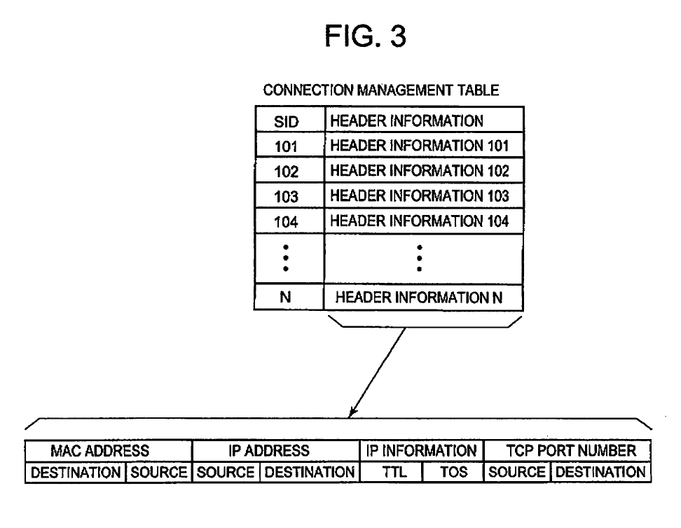

Referring to FIG. 3, the connection management table of the connection manager 13 has a SID (Session IDentifier) field and a header information field. Here, header information 101 to N each corresponding to SIDs 101 to N are contained in the connection management table.

Header information contains source and destination MAC (Media Access Control) address fields, source and destination IP (Internet Protocol) address fields, IP header TTL (Time To Live) and TOS (Type Of Service) fields, and source and destination TCP port number fields.

IP packet Reception and Transmission

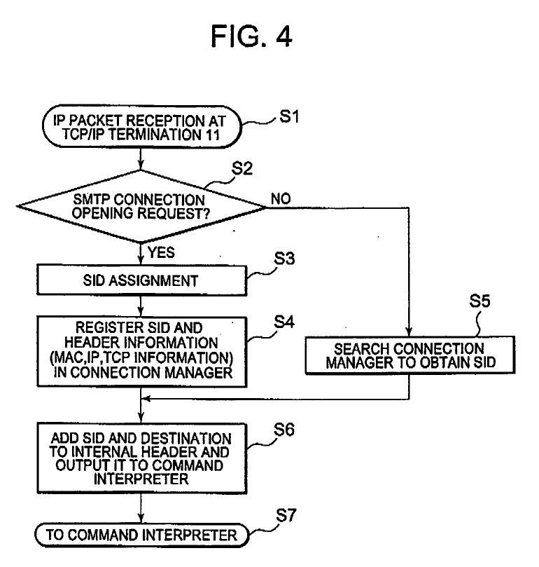

When a SMTP connection request has been received from the SMTP client 2, the TCP/IP termination 11 performs TCP/IP termination processing as shown in FIG. 4.

Referring to FIG. 4, when having received an IP packet (step S1), the TCP/IP termination 11 determines whether it is a SMTP connection opening request (step. S2). When the SYN (synchronous) flag of the received IP packet has been set effective in TCP, it is determined that the received IP packet is the SMTP connection opening request (YES in step S2) and a connection is established according to the predetermined sequence so-called TCP 3-way sequence.

When the connection has been established, the TCP/IP termination 11 assigns SID to that connection (step S3) and registers the header information (source and destination MAC addresses, source and destination IP addresses, and source and destination TCP port numbers) of the received IP packet corresponding to the assigned SID into the connection management table as shown in FIG. 3 (step S4).

Further, the TCP/IP termination 11 adds SID information and internal destination (that is, TCP/IP termination 12) to the internal header and outputs it to the command interpreter 14 (step S6).

On the other hand, when the received IP packet is not the SMTP connection opening request (NO in step S2), the TCP/IP termination 11 searches the connection management table of the connection manager 13 for its header information (IP address and TCP port number) to obtain SID (step S5). Thereafter, the TCP/IP termination 11 adds the SID information and internal destination to internal header and outputs it to the command interpreter 14 (step S6, S7).

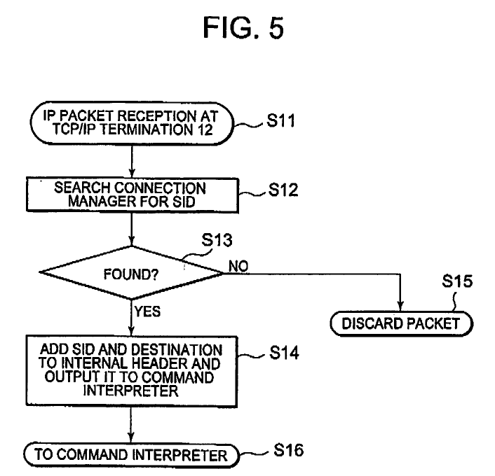

Referring to FIG. 5, when having received an IP packet (step S11), the TCP/IP termination 12 searches the connection management table of the connection manager 13 for its header information (IP address and TCP port number) so as to obtain SID (step S12). When SID is found (YES in step S13), the TCP/IP termination 12 adds the obtained SID information and internal destination (that is, TCP/IP termination 11) to internal header and outputs it to the command interpreter 14 (step S14, S16). When not found (NO in step S13), the TCP/IP termination 12 discards that packet (step S15).

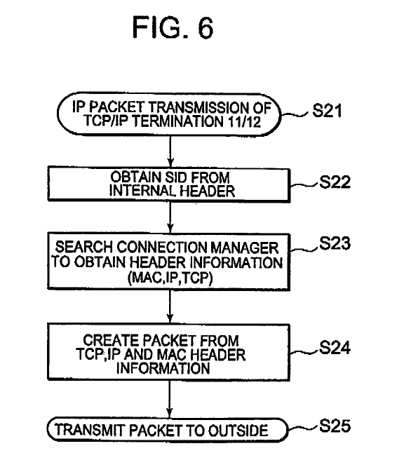

Referring to FIG. 6, when transmitting an IP packet (step S21), the TCP/IP termination 11 or 12 obtains SID from the internal header (step S22) and searches the connection management table of the connection manager 13 for its header information (IP address and TCP port number) to obtain header information (step S23).

Using the obtained header information, that is, MAC header, IP header and TCP port, the TCP/IP termination 11 or 12 creates an IP packet (step S25) and transmits it to outside (step S25).

By using the connection manager 13 as described above, the mail filter device 1 can transmit the same packet header as that transmitted by the SMTP client 2 to the SMTP server 3.

Command Response Packet Processing

Hereinafter, processing of a command response packet transmitted from the SMTP server to the SMTP client will be described. It should be noted that the source and destination relationship in the case of the SMTP client receiving a packet from the SMTP server is the reverse of that in the case of the SMTP client transmitting a packet to the SMTP server.

When having received a packet, the TCP/IP termination 12 interchanges the destination field and the source field of MAC address, IF address and TCP port number before searching the connection manager 13, thereby obtaining a corresponding SID from the connection manager 13. The TCP/IP termination 12 adds the obtained SID and the flag indicating a signal received from the SMTP server to a message packet after termination, and outputs it to the command interpreter 14. The command interpreter 14 recognizes that this is a response received from the SMTP server, and passes response message information to the SMTP processor 15. The SMTP processor 15 uses the response message information as well as command information to perform SMTP protocol processing.

When a response message to be sent to the SMTP client has been determined by the SMTP protocol processing, the response message is transferred to the TCP/IP termination 11 via the SMTP processor 15 and the command interpreter 14.

The TCP/IP termination 11 uses the SID attached to the response message to query the connection manager 13 to find header information. In this header information, since a thing to be transmitted is a response message, the TCP/IP termination 11 replaces the destination field and the source field with those registered in the connection management table of the connection manger 13.

According to the present embodiment, this header information is added to the packet header of TCP/IP, so that a packet having the same header as the header of the packet that has been received from the SMTP server can be transmitted to the SMTP client.

TCP protocol stack of the TCP/IP terminations 11 and 12 is a well-known TCP termination standard (e.g. RFC793 September 1981, pp. 15-23, 30 and 31) and therefore its descriptions are omitted.

The above-described operation descriptions of the TCP/IP terminations 11 and 12 are defined with respect to SMTP client 2/SMTP server 3 and do not correspond to physical ports in a one-to-one relationship.

For example, consider that electronic mails exchanged between two computers X and Y according to SMTP. When the computer X sends an electronic mail to the computer Y, the computer X is a client and the computer Y is server. In this case, the TCP/IP termination 11 is connected to the computer X and the TCP/IP termination 12 is connected to the computer Y. On the other hand, when the computer Y sends an electronic mail to the computer X, the computer Y is a client and the computer X is server. In this case, the TCP/IP termination 11 is connected to the computer Y and the TCP/IP termination 12 is connected to the computer X.

The command interpreter 14 receives an octet stream after TCP termination from the TCP/IP termination 11 and finds a string of SMTP command characters from the TCP-terminated octet stream to output the SMTP command to the SMTP processor 15. On the other hand, the command interpreter 14 receives an octet stream after TCP termination from the TCP/IP termination 12 and finds a string of SMTP response characters from the TCP-terminated octet stream to output the SMTP command to the SMTP processor 15.

The SMTP processor 15 interprets a SMTP sequence for each SID to extract a data string necessary for retrieval from the command data and the message data. The SMTP processor 15 uses the extracted data string to query the retrieval section 16.

The retrieval section 16 searches the information table composed of the unknown user registration table 17-1, the user table 17-2 and the blacklist 17-3 and returns its search result to the SMTP processor 15. When the SMTP processor 15 determines that transmission of an error notice mail is needed, the error transmission controller 18 is instructed to send an electronic mail. The error transmission controller 18 is a client implemented by software running on a CPU (central processing unit).

SMTP Processing

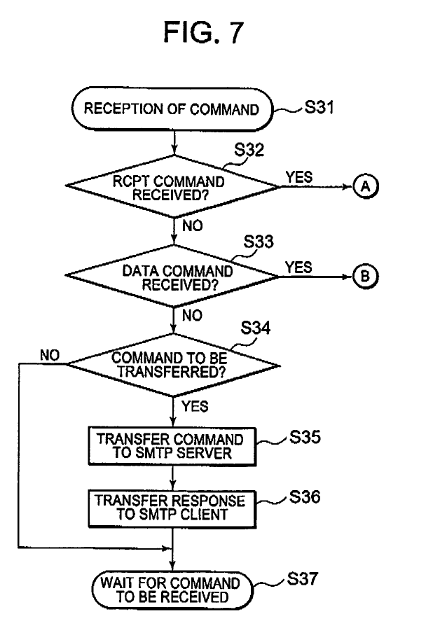

Hereinafter, protocol processing of the SMTP processor 15 will be described with reference to FIGS. 7-10.

Referring to FIG. 7, when having received a SMTP command from the SMTP client 2 (step S31), the SMTP processor 15 determines whether it is a RCPT (RECIPIENT) command (step S32). A RCPT command is a command for notifying the SMTP server 3 of a destination address. When it is not a RCPT command (NO in step S32), it is further determined whether the received command is a DATA command (step S33). When it is not a DATA command (NO in step S33), it is still further determined whether the received command is a command to be transferred (step S34).

When the received command is not RCPT or DATA command but a command to be transferred (YES in step S34), the SMTP processor 15 transfers the received command to the SMTP server 3 (step S35) and transfers a response from the SMTP server 3 to the SMTP client 2 (step S36). Thereafter, the SMTP processor 15 waits for a command to be received (step S37).

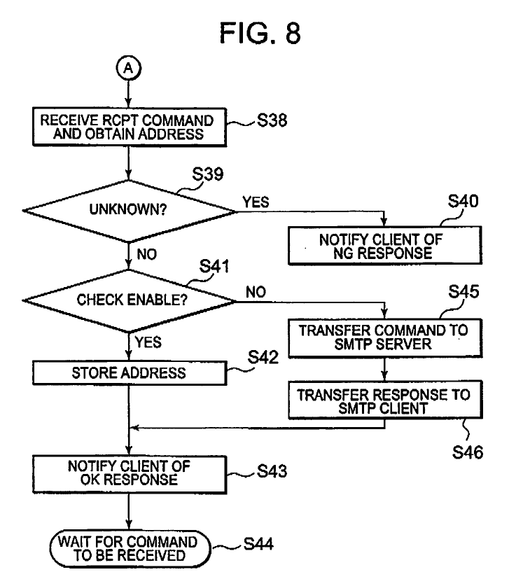

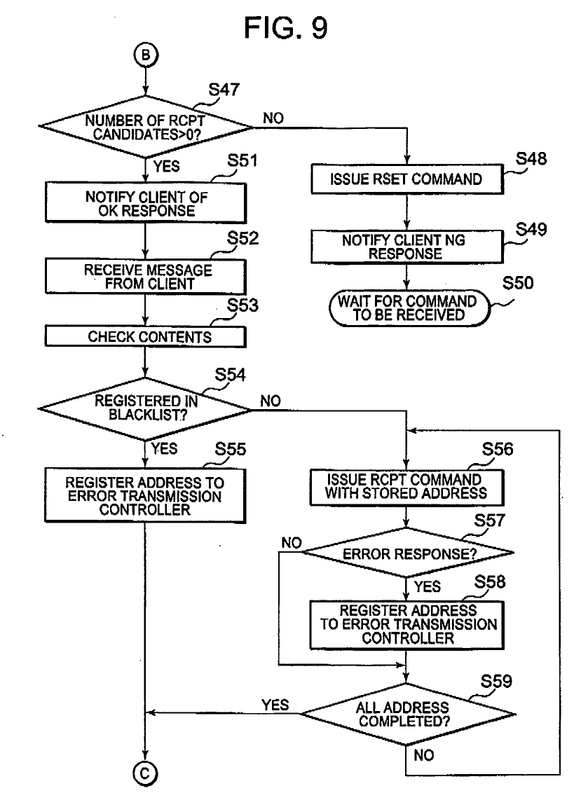

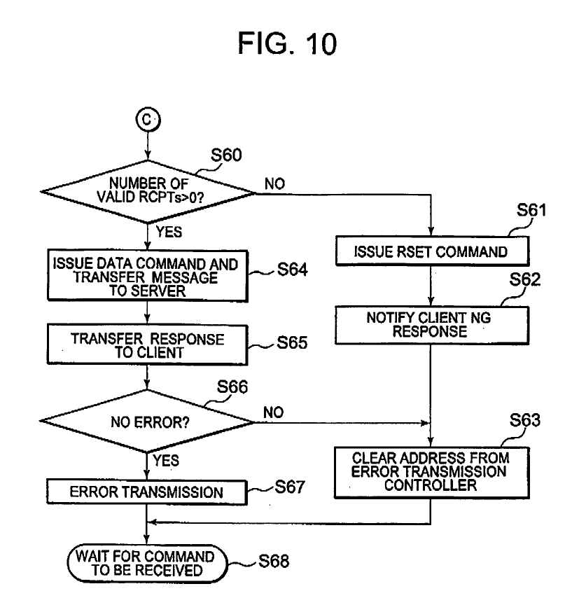

When the received SMTP command is a RCPT command (YES in step S32), the control goes to the steps as shown in FIG. 8, which will be described below. When the received SMTP command is a DATA command (YES in step S33), the control goes to the steps as shown in FIGS. 9 and 10, which will be also described below.

Referring to FIG. 8, when the received SMTP command is a RCPT command (YES in step S32), the SMTP processor 15 obtains an address from the RCPT command (step S38) and performs unknown check by instructing the retrieval section 16 to search the unknown user registration table 17-1 (step S39). The unknown check is performed by the retrieval section 16 using a table to be searched, which is designated by the SMTP processor 15. The unknown check will be described later.

When the retrieval result is “unknown”, that is, it is found in the unknown user registration table 17-1 (YES in step S39), the SMTP processor 15 notifies the SMTP client 2 of a NG response without transferring the RCPT command to the SMTP server 3 (step S40).

When it is not registered in the unknown user registration table 17-1 (NO in step S39), the SMTP processor 15 performs enable check to receive from the user table 17-2a filter check result which indicates “enable” or “disable” (step S41).

When the filter check result is “enable” (YES in step S41), the SMTP processor 15 temporarily stores the address in a memory (not shown) so as to put on hold determination to transfer the RCPT command until the body of an electronic mail has been completely checked (step S42) and notifies an OK response to the SMTP client 2 (step S43).

When the filter check result is “disable” (NO in step S41), the SMTP processor 15 transfers the RCPT command to the SMTP server 3 because a message is relayed independently of checking the body of an electronic mail (step S45). Since a response to the RCPT command is received from the SMTP server 3, the response is transferred to the SMTP client 2 (step S46).

Referring to FIG. 9, when the received SMTP command is a DATA command (YES in step S33 of FIG. 7), the SMTP processor 15 determines whether the number of RCPT candidates is positive (step S47). A RCPT candidate indicates a destination address other than unknown user addresses obtained from a RCPT command received from the SMTP client 2.

When the number of RCPT candidates is positive (YES in step S47), it means that some destination address exist to which a message is allowed to be transferred. Accordingly, the SMTP processor 15 notifies the SMTP client 2 of an OK response to the DATA command (step S51). In response to the OK response, the SMTP processor 15 receives the message of an electronic mail from the SMTP client 2 (step S52).

The SMTP processor 15 divides the body data of the message of the electronic mail into constant-length data pieces and outputs each piece of data to the retrieval section 16 for content check (steps S53, S54). In the content check, the SMTP processor 15 designates the type of an information table to be searched. For example, when retrieving URL (Uniform Resource Locator) included in the body of an electronic mail, the blacklist table 17-3 storing a black list of URLs will be designated.

When a match is found in the blacklist 17-3 by the content check (YES in step S54), the electronic mail to the temporarily stored destination address having the filter check result being “enable”, is not transferred. The SMTP processor 15 registers that address onto the error transmission controller 18 so as to notify that the destination address temporarily stored at the step S42 indicating that the filter check result is “enable” is an error address (step S55).

When no match is found in the blacklist 17-3 (NO in step S54), the SMTP processor 15 issues a RCPT command for the destination address that has been stored at the step S42 (see FIG. 8) regardless of whether the check result is enable/disable so as to notify the SMTP server 3 of the destination address of a RCPT candidate (step S56).

Thereafter, the SMTP processor 15 monitors a response received from the SMTP server 3 to determine whether an error occurs (step S57). When the occurrence of error is determined (YES in step S57), the SMTP processor 15 registers the address information to the error transmission controller 18 to perform error transmission because the OK response has been notified to the SMTP client 2 (step S58).

The steps S56-S58 are repeatedly performed until RCPT commands for all stored addresses have been completed issued (step S59). When all the stored addresses have been completed (YES in step S59) or after the address registration (step S55), common steps as shown in FIG. 10 to both cases where a match is found in the blacklist 17-3 and where not found will follow.

Referring to FIG. 10, first, the SMTP processor 15 determines whether the number of valid RCPTs is positive (step S60). Actually the number of valid RCPTs is the number of destination addresses to be relayed by the mail filter device 1. In other words, when a match is found in the blacklist by the content check, a RCPT address with the check result being “enable” is made invalid and a RCPT address with the check result being “disable” is made valid. Accordingly, the number of addresses with the check result being “disable” is the number of valid RCPTs.

When the number of valid RCPTs is positive (YES in step S60), the SMTP processor 15 issues a DATA command to the SMTP server 3 and, when an OK response is received from the SMTP server 3, transfers the body of the electronic mail to the SMTP server 3 (step S64).

After the body of the electronic mail has been completed transferred, a response thereto is received from the SMTP server 3 and the value of the received response is transferred to the SMTP client 2 (step S65). In this manner, the filter relay of the electronic mail is completed.

Thereafter, the SMTP processor 15 determines whether an error is indicated in the response received from the SMTP server 3 (step S66). When no error occurs and address information has been registered in the error transmission controller 18 (YES in step S66), the error transmission controller 18 creates an error notice mail and transmits it (step S67).

When the number of valid RCPTs is zero (NO in step S60), the SMTP processor 15 issues a RSET (RESET) command to the SMTP server 3 because there is no destination address to be relayed to the SMTPO server 3 (step S61). In addition, the SMTP processor 15 notifies the SMTP client 2 of a NG response indicating transfer failure (step S62). A RSET command is a command for resetting the session to its initial state by clearing the source address and destination address notified to a server.

After the NG response has been notified to the SMTP client 2 (step S62) or when some error exists (NO in step S66), the SMTP processor 15 clears address information registered in the error transmission controller 18 because it is unnecessary to send an error notice for the stored address (step S63).

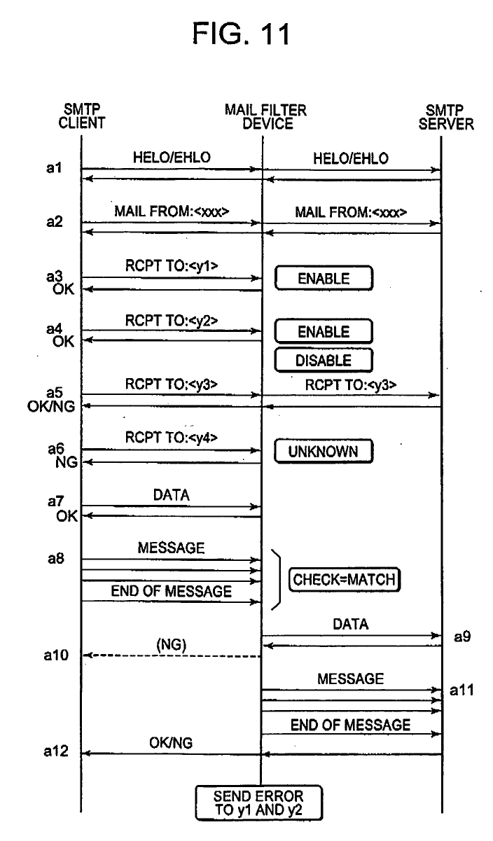

Hereinafter, several examples of transfer processing according to the present invention will be described with reference to FIGS. 11-13.

### EXAMPLE I

A first example shows the case where only an electronic mail with its check result being “disable” that is included in the blacklist 17-3 is permitted to pass through.

As shown in FIG. 11, the SMTP client 2 first issues a command such as HELO (HELLO) or EHLO (Extended HELLO) to the SMTP server 3. The mail filter device 1 receives this HELO/EHLO command and transfers it as it is to the SMTP server 3. When receiving a response to the HELO/EHLO command from the SMTP server 3, the mail filter device 1 transfers the response to the SMTP client 2 (step a1). Here, a HELO command is an opening command when a session is initiated. An EHLO command is an opening command for notifying a request asking the extended function. According to these commands, a session with a client is initiated at a server.

Subsequently, the SMTP client 2 issues a MAIL command for source address notification. The mail filter device 1 also transfers this MAIL command to the SMTP server 3 and transfers its response back to the SMTP client 2 (step a2).

Thereafter, the SMTP client 2 issues a RCPT command to notify the destination of an electronic mail. This RCPT command can be issued a plurality of times with designating a plurality of destinations of the electronic mail (steps a3-a6).

More specifically, in the RCPT command at the step a3, the destination address is designated as “y1”. As described before, the mail filter device 1 performs the unknown check and the filter enable check to this command. It is assumed that the filter processing of “y1” is “enable”. Similarly, in the RCPT command at the step a4, the destination address is designated as “y2” and it is assumed that the filter processing of “y2” is “enable”.

In the RCPT command at the step a5, however, it is assumed that the destination address is designated as “y3” and the filter processing of “y3” is “disable”. In this case, the mail filter device 1 transfers the RCPT command to the SMTP server and also transfers a response received from the SMTP server 3 to the SMT client 2. At this time, when the response value is a code number indicating NG, “y3” does not become a RCPT candidate.

In the RCPT command at the step a6, it is assumed that the destination address is designated as “y4” and it is determined that the address is unknown. In this case, the mail filter device 1 transmits a response indicating NG to the SMTP client 2 and “y4” does not become a RCPT candidate.

In the above-described example, the number of RCPT candidates is 3 and therefore the mail filter device 1 transmits a response indicating OK in response to reception of a DATA command (step a7). When the SMTP client 2 transmits the message of the electronic mail, the mail filter device 1 performs the content check to determine whether a match is found in the blacklist 17-3.

When it is determined that the message transmission has been completed and no match is found in the blacklist 17-3, the mail filter device 1 does not deliver the electronic mail to “y1” and “y2” with filter check result being “enable”. Accordingly, “y1” and “y2” are registered in the error transmission controller 18.

Although the valid RCPT is only “y3”, the number of valid RCPTs is not zero and therefore the mail filter device 1 issues a DATA command to the SMTP server 3 (step a9). If a NG response is returned from the SMTP server 3, then the mail filter device 1 sends a NG response to the SMTP client 2 without sending the message of the electronic mail to the SMTP server 3 (step a10).

When a response to the DATA command is OK, the mail filter device 1 transfers the message of the electronic mail to the SMTP server 3 (step all) and, after the message transfer has been completed, sends a response to the SMTP client 2 (step a12).

In the case where the electronic mail has been successfully delivered, the SMTP server 3 is supposed to send an OK response back and therefore the mail filter device 1 relays the OK response too the SMTP client 2. Since the SMTP client 2 receives an OK response to the DATA command (message transfer), the SMTP client 2 can release the message that is stored for transmission.

When an OK response is received at the step a12, the mail filter device 1 transmits an error mail to “y1” and “y2” registered in the error transmission controller 18. In the case of NG at the steps a10 or a12, the mail filter device 1 clears “y1” and “y2” registered in the error transmission controller 18 without transmitting an error mail.

### EXAMPLE II

A second example shows the case where the content check determines that a match is found in the blacklist 17-3 and the electronic mail is not delivered.

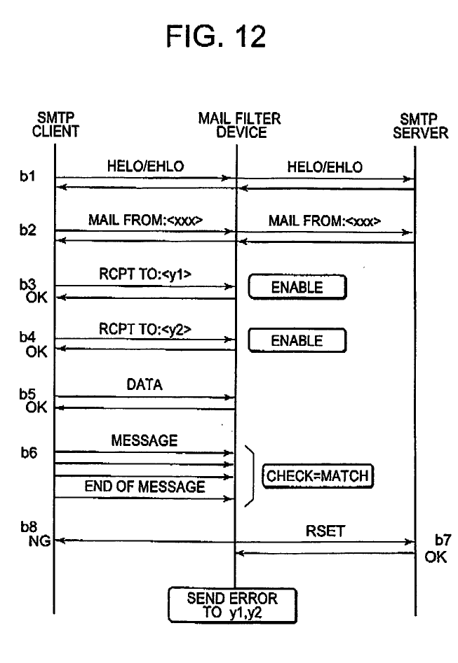

As shown in FIG. 12, HELO/EHLO command transfer (step b1) and MAIL command transfer (step b2) are similar to those in the first example as shown in FIG. 11.

In the RCPT command at the step b3, it is assumed that the destination address is designated as “y1” and the filter processing of “y1” is “enable”. Similarly, in the RCPT command at the step b4, it is assumed that the destination address is designated as “y2” and the filter processing of “y2” is “enable”.

Subsequently, the mail filter device 1 performs the content check on the message of an electronic mail received from the SMTP client 2 by exchanging DATA command and OK response (steps b5 and b6). If it is determined that a match is found in the blacklist 17-3, then “y1” and “y2” are deleted from a list of RCPT candidates, resulting in the number of RCPT candidates being zero. Then the mail filter device 1 issues a RSET command to the SMTP server 3 to clear MAIL command information or the like which have been issued so far (step b7).

On the other hand, the mail filter device 1 transmits a NG response to the SMTP client 2 to notify that mail transfer has been completed in failure (step b8). When having received the NG response to DATA command, the SMTP client 2 performs appropriate error transmission processing before releasing the message that is stored for transmission.

### EXAMPLE III

A third example shows the case where the content check determines that no match is found in the blacklist 17-3 and the electronic mail is delivered to all destination addresses.

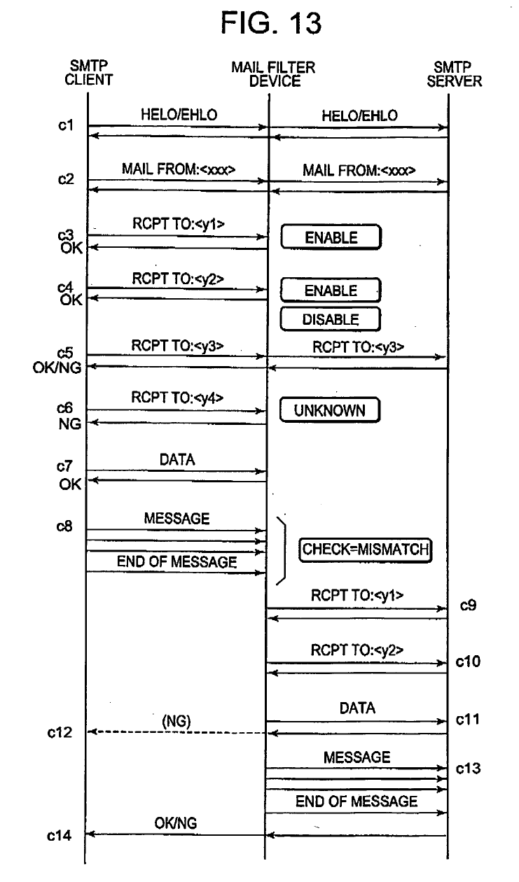

In FIG. 13, steps c1-c7 are similar to the steps a1-a7 of FIG. 11. Here, it is assumed that destination “y3” is sent to the SMTP server 3 regardless of filter check result, the filter processing of “y1” and “y2” is “enable”, and destination “y4” is unknown and therefore a NG response is sent back.

Subsequently, the mail filter device 1 receives the message of the electronic mail from the SMTP client 2 and performs the content check (step c8). Assuming that no match is found in the black list 17-3 by the content check, mail transfer is also performed to the stored destinations “y1” and “y2”. Accordingly, the mail filter device 1 issues a RCPT command for “y1” and “y2” to the SMTP server 3. Mores specifically, at step c9, RCPT command is used to notify the SMTP server 3 of “y1” and, at step c10, RCPT command is used to notify the SMTP server 3 of “y2”. If a response indicative of error is received from the SMTP server 3, then the address is registered in the error transmission controller 18 as described before.

Thereafter, the mail filter device 1 issues a DATA command to the SMTP server 3 (step c11). If a NG response is returned from the SMTP server 3, then the mail filter device 1 sends a NG response to the SMTP client 2 (step c12). When a response to the DATA command is OK, the mail filter device 1 transfers the message of the electronic mail to the SMTP server 3 (step c13).

After the message transfer has been completed, the mail filter device 1 sends a response received from the SMTP server 3 to the SMTP client 2 (step c14). When the response received from the SMTP server 3 is indicative of OK and some address has been registered in the error transmission controller 18, the mail filter device 1 performs transmission processing of an error notice mail. When the response received from the SMTP server 3 is indicative of NG, the address registered in the error transmission controller 18 is cleared. Regardless of whether or not a response is received from the SMTP server 3, the mail filter device 1 is not burdened with the responsibility of data delivery but the SMTP client 2 until a response has been received after the data transfer completion.

Unknown User Registration Table

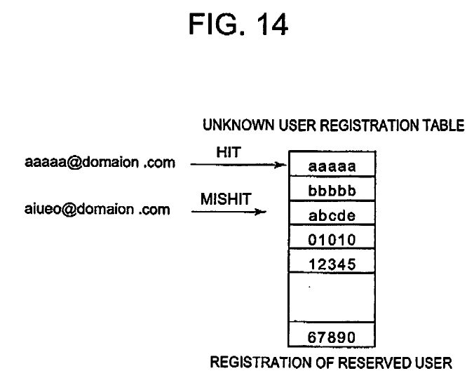

Referring to FIG. 14, the unknown user registration table 17-1 registers unknown users for the purpose of efficient retrieval of unknown destination addresses even when a database stores an enormous amount of destination user data and therefore all users cannot be registered.

In general, when the number of users to be checked exceeds 10 million, a user database on another computer is used to query about the presence or absence of user or check service in interest. However, such an approach is disadvantageously time-consuming. In contrast, according to the present embodiment, the addresses of unknown users, which do not exist actually, are previously registered in the unknown user registration table 17-1. If a match is found in the previously registered addresses, then an error is returned as an unknown user.

As known well, a mail address consists of a local section and a domain section, which are separated by a special character “@”, for example, “local@domain”. According to SMTP standard, it is determined that the maximum lengths of the local section and the domain section are 64 characters and 256 characters, respectively.

On the other hand, it is considered that a sender of nuisance mails wishes to transmit a large number of mails efficiently by automatically generating mail addresses. In such a case, addresses of a relatively short length would be generated because a long string of characters resulting in an increased number of combinations of characters and therefore a reduced possibility that it matches an authorized user. Accordingly, addresses of a limited length are registered as unknown users. For example, reserved addresses having a local section of 5 or less characters may be registered in the unknown user registration table 17-1. A reserved address is defined as a string of characters reserved for unknown determination, which may not be used among general users.

The unknown determination is provided by character retrieval using the retrieval section 16 and the unknown user registration table 17-1. To reduce the size of the unknown user registration table 17-1, frequently used unknown addresses may be collected from error mails to register them into the unknown user registration table 17-1.

The unknown user registration table shown in FIG. 14 registers “aaaaa”, “bbbbb”, “abcde”, “01010” and so on as reserved addresses. When a destination address of an electronic mail is “aaaaa@domain.com”, such a mail address having a reserved local section is found in the unknown user registration table, which means that this mail may be a nuisance mail.

### Second Embodiment

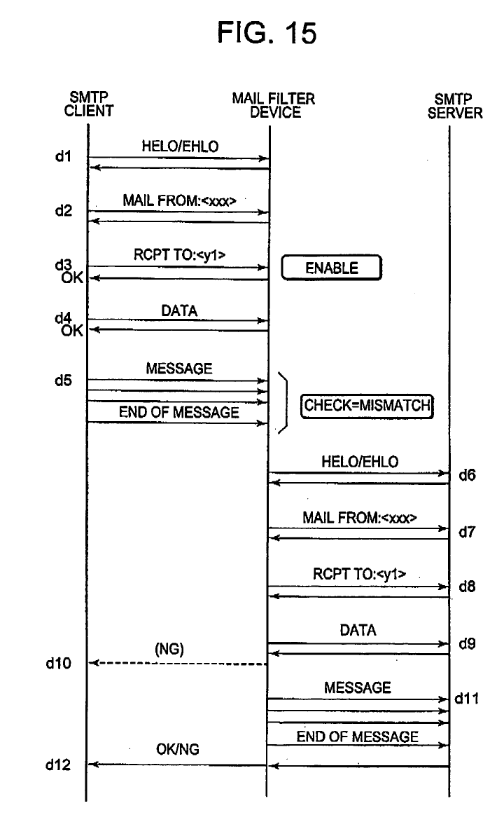

A mail filter system according to a second embodiment of the present invention is similar to that of the first embodiment as shown n FIG. 2. Transfer processing according to the second embodiment of the present invention will be described with reference to FIG. 15.

According to the second embodiment, relay processing to the SMTP server 3 is delayed until the content check result is determined. Even when the number of destinations to which an electronic mail is to be relayed becomes zero resulting from the content check result, no connection to the SMTP server 3 is made, allowing lightened load on the SMTP server 3.

As shown in FIG. 15, when receiving a HELO/EHLO command from the SMTP client 2, the mail filter device 1 does not immediately send it to the SMTP server 3 but a preset response back to the SMTP client 2 (step d1).

Subsequently, when receiving a MAIL command, the mail filter device 1 sends only an OK response back to the SMTP client 2 (step d2). When receiving a RCPT command from the SMTP client 2, the mail filter device 1 performs the unknown check and then the filter check to determine “enable” or “disable”, which are described before.

When the destination address is unknown, the mail filter device 1 sends a NG response back to the SMTP client 2. At other times, an OK response is sent back to the SMTP client 2 (step d3). The mail filter device 1 receives data from the SMTP client 2 and performs the content check using the SMTP processor 15, the retrieval section 16, and the information table (steps d4 and d5).

When a match is found in the blacklist 17-3, the mail filter device 1 deletes a check-enable address from the address list and determines that the remaining addresses in the address list become address candidates to be relayed to the SMTP server 3. At this time, if the number of RCPT candidates is not zero, then the mail filter device 1 performs relay processing to the SMTP server 3.

More specifically, the mail filter device 1 issues a HELO/EHLO command to the SMTP server 3 (step d6) and then a MAIL command (step d7). Further, the mail filter device 1 issues a RCPT command for destination addresses to the SMTP server 3 (step d8).

The mail filter device 1 issues a DATA command to the SMTP server 3 (step d9). If a NG response is returned from the SMTP server 3, then the mail filter device 1 sends a NG response to the SMTP client 2 to inform that mail relay ends in failure (step d10).

When a response to the DATA command is OK, the mail filter device 1 transfers the message of the electronic mail to the SMTP server 3 (step d11) and, after the message transfer has been completed, sends a response to the SMTP client 2 (step d12).

When a response to the RCPT command at step d8 is returned from the SMTP server 3 and is indicative of NG while DATA transfer is successfully completed, it means that only data transfer to a specific user ends in failure and therefore an error notice mail is transmitted by the error transmission controller 18. Further, in the case where destinations having mixed filter check results of “enable” and “disable” exist, the error transmission controller 18 transmits an error notice mail to the destinations having the filter check results of “enable” when the content check determines that a match is found in the blacklist 17-3.

As described above, according to the second embodiment, the connection to the SMTP server 3 is not made until completion of the content check, resulting in reduced time required for connecting to the SMTP server 3 and the reduced number of concurrent connections to the SMTP server 3. In addition, when the content check determines that transfer is not needed, processing itself for connection to the SMTP server 3 is not made, resulting in lightened load on the SMTP server 3.

In flowcharts as shown in FIGS. 7-10, the unknown check for address and the filter check of enable/disable determination are performed. However, in the case where filter functions are applied in a collective manner, these checks may be omitted. In such a case, it is assumed that all mail addresses obtained from RCPT command are “enable” in the filter check and they are processed according to the processing flows as shown in FIGS. 7-10.

1. A mail filter system comprising:
a client device;
a server device; and
a mail filtering device for filtering electronic mails, at which an electronic mail is relayed between the client device and the server device, wherein the mail filtering device comprises:
a connection manager which registers header information before and after relaying the electronic mail, wherein header information established for one of the client-side connection and the server-side connection is used for the other one of the client-side connection and the server-side connection.

2. The mail filter system according to claim 1, wherein the header information conforms to TCP/IP (Transmission Control Protocol/Internet Protocol).

3. The mail filter system according to claim 2, wherein the electronic mail is relayed based on SMTP (Simple Mail Transfer Protocol).

4. The mail filter system according to claim 3, wherein the mail filtering device further comprises:
a SMTP processor performing issue and transfer of a command and its response for the client device and the server device when relaying the electronic mail.

5. The mail filter system according to claim 4, wherein the SMTP processor performs relaying the command and response exchanging between the client device and the server device and, when relaying a message of the electronic mail, performs content check on the message of the electronic mail.

6. The mail filter system according to claim 5, wherein when a result of the content check indicates that the electronic mail is relayed without discarding the message of the electronic mail, the SMTP processor transfers the response to the client device on completion of relay processing by the server device.

7. The mail filter system according to claim 2, wherein the mail filtering device further comprises:
a termination section for terminating TCP/IP for each of the client device and the server device, wherein the connection manager allows the termination section for each of the client device and the server device to share the TCP/IP header information.

8. The mail filter system according to claim 4, wherein the mail filtering device further comprises:
a termination section for terminating TCP/IP for each of the client device and the server device, wherein the connection manager allows the termination section for each of the client device and the server device to share the TCP/IP header information.

9. The mail filter system according to claim 2, wherein the mail filtering device further comprises:
a retrieval section for determining whether a destination address of the electronic mail matches a predetermined destination unknown address when the electronic mail is relayed.

10. The mail filter system according to claim 4, wherein the mail filtering device further comprises:
a retrieval section for determining whether a destination address of the electronic mail matches a predetermined destination unknown address when the electronic mail is relayed.

11. The mail filter system according to claim 7, wherein the mail filtering device further comprises:
a retrieval section for determining whether a destination address of the electronic mail matches a predetermined destination unknown address when the electronic mail is relayed.

12. The mail filter system according to claim 2, wherein the mail filtering device performs connecting to the server device after completion of content check on a message of the electronic mail.

13. The mail filter system according to claim 5, wherein the mail filtering device performs connecting to the server device after completion of the content check.

14. A mail filter device for filtering electronic mails, at which an electronic mail is relayed between a client device and a server device, comprising;
a connection manager which registers header information before and after relaying the electronic mail, wherein header information established for one of the client-side connection and the server-side connection is used for the other one of the client-side connection and the server-side connection.

15. The mail filter device according to claim 14, wherein the header information conforms to TCP/IP (Transmission Control Protocol/Internet Protocol).

16. The mail filter device according to claim 15, wherein the electronic mail is relayed based on SMTP (Simple Mail Transfer Protocol).

17. The mail filter device according to claim 16, further comprising:
a SMTP processor performing issue and transfer of a command and its response for the client device and the server device when relaying the electronic mail.

18. The mail filter system according to claim 17, wherein the SMTP processor performs relaying the command and response exchanging between the client device and the server device and, when relaying a message of the electronic mail, performs content check on the message of the electronic mail.

19. The mail filter device according to claim 18, wherein when a result of the content check indicates that the electronic mail is relayed without discarding the message of the electronic mail, the SMTP processor transfers the response to the client device on completion of relay processing by the server device.

20. The mail filter device according to claim 15, further comprising:
a termination section for terminating TCP/IP for each of the client device and the server device, wherein the connection manager allows the termination section for each of the client device and the server device to share the TCP/IP header information.

21. The mail filter device according to claim 17, wherein the mail filtering device further comprises:
a termination section for terminating TCP/IP for each of the client device and the server device, wherein the connection manager allows the termination section for each of the client device and the server device to share the TCP/IP header information.

22. The mail filter device according to claim 15, wherein the mail filtering device further comprises:
a retrieval section for determining whether a destination address of the electronic mail matches a predetermined destination unknown address when the electronic mail is relayed.

23. The mail filter device according to claim 17, wherein the mail filtering device further comprises:
a retrieval section for determining whether a destination address of the electronic mail matches a predetermined destination unknown address when the electronic mail is relayed.

24. The mail filter device according to claim 20, wherein the mail filtering device further comprises:
a retrieval section for determining whether a destination address of the electronic mail matches a predetermined destination unknown address when the electronic mail is relayed.

25. The mail filter device according to claim 15, wherein the mail filtering device performs connecting to the server device after completion of content check on a message of the electronic mail.

26. The mail filter device according to claim 18, wherein the mail filtering device performs connecting to the server device after completion of the content check.

27. A mail filtering method for filtering electronic mails and relaying an electronic mail between a client device and a server device, comprising:
registering header information before and after relaying the electronic mail; and
using header information established for one of the client-side connection and the server-side connection as header information for the other one of the client-side connection and the server-side connection.

28. The mail filtering method according to claim 27, wherein the header information conforms to TCP/IP (Transmission Control Protocol/Internet Protocol).

29. The mail filtering method according to claim 28, wherein the electronic mail is relayed based on SMTP (Simple Mail Transfer Protocol).

30. The mail filtering method according to claim 29, further comprising:
performing issue and transfer of a command and its response for the client device and the server device when relaying the electronic mail.

31. The mail filtering method according to claim 30, wherein the step of performing issue and transfer of a command and its response comprises:
relaying the command and response exchanging between the client device and the server device and, when relaying a message of the electronic mail, performs content check on the message of the electronic mail.

32. The mail filtering method according to claim 31, wherein when a result of the content check indicates that the electronic mail is relayed without discarding the message of the electronic mail, the step of performing issue and transfer of a command and its response comprises:
transferring the response to the client device on completion of relay processing by the server device.

33. The mail filtering method according to claim 28, further comprising:
terminating TCP/IP for each of the client device and the server device, wherein termination for each of the client device and the server device shares the TCP/IP header information.

34. The mail filtering method according to claim 30, further comprising:
terminating TCP/IP for each of the client device and the server device, wherein termination for each of the client device and the server device shares the TCP/IP header information.

35. The mail filtering method according to claim 28, further comprising:
determining whether a destination address of the electronic mail matches a predetermined destination unknown address when the electronic mail is relayed.

36. The mail filtering method according to claim 30, further comprising:
determining whether a destination address of the electronic mail matches a predetermined destination unknown address when the electronic mail is relayed.

37. The mail filtering method according to claim 33, further comprising:
determining whether a destination address of the electronic mail matches a predetermined destination unknown address when the electronic mail is relayed.

38. The mail filtering method according to claim 28, further comprising:
connecting to the server device after completion of content check on a message of the electronic mail.

39. The mail filtering method according to claim 31, further comprising:
connecting to the server device after completion of content check on a message of the electronic mail.

40. A computer-readable program instructing a computer to filter electronic mails and relaying an electronic mail between a client device and a server device, the program comprising:
registering header information before and after relaying the electronic mail; and
using header information established for one of the client-side connection and the server-side connection as header information for the other one of the client-side connection and the server-side connection.

41. The computer-readable program according to claim 40, wherein the header information conforms to TCP/IP (Transmission Control Protocol/Internet Protocol).

42. The computer-readable program according to claim 40, further comprising:
determining whether a destination address of the electronic mail matches a predetermined destination unknown address when the electronic mail is relayed.
